(19) United States
(12) Patent Application Publication
(10) Pub. No.: US 2008/0038017 A1
(43) Pub. Date: Feb. 14, 2008

(54) METHOD AND APPARATUS FOR IMAGE FORMING FOR EFFECTIVELY CHARGING AN IMAGE CARRIER

(76) Inventors: Tetsumaru FUJITA, Hyogo-ken (JP); Yuji Nagatomo, Osaka (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/837,155

(22) Filed: Aug. 10, 2007

(30) Foreign Application Priority Data
Aug. 11, 2006 (JP) 2006-219116

(51) Int. Cl. G03G 15/02

(52) U.S. Cl. 399/175; 399/50

(57) ABSTRACT

An image forming apparatus, performing a corresponding method of image forming, includes an image carrier, a charging unit including a first charging member for discharging a given amount of bias to a portion contacting the image carrier and uniformly charging the surface of the image carrier while contacting the surface of the image carrier, a charge bias applying unit for applying a charge bias including at least an alternating current voltage to the first charging member, a writing unit, and a developing unit. In the image forming apparatus, a ratio of a frequency of the alternating current voltage to a surface linear velocity of the image carrier is within a range of from approximately 1.5:1 to approximately 4:1 and a ratio of a surface linear velocity of the first charging member to the surface linear velocity of the image carrier is at least 2:1.

### CROSS REFERENCE TO RELATED APPLICATIONS

The present patent application claims priority under 35 U.S.C. §119 from Japanese Patent Application No. 2006-219116 filed on Aug. 11, 2006 in the Japan Patent Office, the entire contents and disclosure of which are hereby incorporated by reference herein in their entirety.

### BACKGROUND OF THE INVENTION

1. Field of the Invention

Exemplary embodiments of the present invention generally relates to a method and apparatus for image forming for effectively charging, and more particularly, to an image forming apparatus that effectively charges an image carrier with a given charge bias without causing charging non-uniformity and/or filming, and an image forming method used in the image forming apparatus.

2. Discussion of the Related Art

In related-art image forming apparatuses, a charging member applies a given charge bias to a target member to be charged. For example, the charging member applies a charge bias including a direct current voltage only, a charge bias including an alternating current voltage superimposed on a direct current voltage, and so forth.

Compared to the charge bias including an alternating current voltage superimposed on a direct current voltage, the charge bias including a direct current voltage only can easily cause non-uniformity in charging or charging non-uniformity on a target member. However, even with the charge bias including an alternating current voltage superimposed on a direct current voltage, charging non-uniformity cannot be avoided depending on the frequency of alternating current voltage.

To eliminate the above-described drawbacks, a known technique has been proposed for charging a bias without causing charging non-uniformity by ensuring that a ratio between a frequency “f” [Hz] or an alternating current voltage to a linear velocity “V” [mm/sec] of a drum-shaped image carrier is not less than 4:1 but not greater than 7:1. In other words, the frequency “f” of the alternating current voltage is at least 4 times but not more than 7 times greater than the linear velocity “V”.

By using the alternating current voltage having a value within the above-described range, charging non-uniformity on the image carrier can be reduced.

However, although the foregoing technique can reduce charging non-uniformity on the image carrier, the inventors of the present invention have found through tests that filming can easily be caused using such technique.

Filming is a phenomenon in which toner, dust, and/or other foreign material are firmly affixed to the surface of an image carrier in a film-like form. The inventors of the present invention have conducted tests related to charge biases and charging members and found that, as the frequency “f” of the alternating current voltage increases, filming occurs on the surface of the image carrier more easily. It is believed that, as the frequency “f” increases, the number of electrical discharges between the image carrier and the charging member increases, thereby easily causing foreign materials such as toner and dust residing between the image carrier and the charging member to be firmly affixed to the surface of the image carrier.

The above-described technique employs an alternating current voltage in which the frequency “f” becomes relatively high as the ratio of the frequency “f” to the linear velocity “V” of the image carrier exceeds 4:1. According to the results of the tests conducted by the inventors of the present invention, such alternating current voltage easily causes filming in a short time, resulting in formation of defective images with black streaks and/or white streaks caused by the filming.

A typical mass-production type image forming apparatus is generally required to be equipped with consumable parts having useful lives capable of reproducing at least 10,000 copies of A4-size sheets. However, in tests conducted by the inventors of the present invention, filming was observed to occur before the end of such useful life span, which is undesirable.

### SUMMARY OF THE INVENTION

Exemplary aspects of the present invention have been made in view of the above-described circumstances, and provides an image forming apparatus that can effectively reduce or prevent, where possible, the occurrence of charging non-uniformity and filming on a member to be charged.

Other exemplary aspects of the present invention provide an image forming method that can be performed in the above-described image forming apparatus.

In one exemplary embodiment, an image forming apparatus includes an image carrier configured to carry an image on a surface thereof and rotate continuously, a charging unit including a first charging member configured to rotate with the image carrier at a portion contacting the image carrier and discharge a given amount of bias to the portion and uniformly charge the surface of the image carrier while contacting the surface of the image carrier, a charge bias applying unit configured to apply a charge bias including at least an alternating current voltage to the first charging member, a writing unit configured to write a latent image on the charged surface of the image carrier, and a developing unit configured to develop the latent image formed on the surface of the image carrier into a visible toner image. A ratio of a frequency of the alternating current voltage to a surface linear velocity of the image carrier is within a range of from approximately 1.5:1 to approximately 4:1 and a ratio of a surface linear velocity of the first charging member to the surface linear velocity of the image carrier is at least 2:1.

The above-described image forming apparatus may further include a second charging member configured to contact a surface thereof with the surface of the image carrier and charge the surface of the image carrier before the surface of the image carrier is uniformly charged by the first charging member. The charge bias applying unit may apply a charge bias including at least a direct current voltage to the second charging member.

The above-described image forming apparatus may further include a transfer unit including a transfer member and configured to transfer the image formed on the image carrier onto a recording medium. The developing unit may include a developer carrier and develop the latent image into the toner image with toner carried on a surface of the developer carrier, and move residual toner adhering to the surface of the image carrier from the image carrier to the surface of the developer carrier after the transfer of the image formed on the image carrier to the recording medium by the transfer unit.

Further, in one exemplary embodiment, a method of image forming includes rotating an image carrier to move a surface thereof continuously, rotating a first charging member to move a surface thereof with the image carrier at a portion contacting the first charging member with the image carrier, applying a first charge bias including at least an alternating current voltage, to the first charging member, applying a second charge bias between the first charging member and the image carrier while rotating and contacting the first charging member with the image carrier and uniformly charging the surface of the image carrier, writing a latent image on the charged surface of the image carrier, developing the latent image formed on the surface of the image carrier into a visible toner image, and maintaining a ratio of a frequency of the alternating current voltage to a surface linear velocity of the image carrier within a range of from approximately 1.5:1 to approximately 4:1 and a ratio of a surface linear velocity of the first charging member to the surface linear velocity of the image carrier at least 2:1.

The above-described method may further include maintaining the ratio of the surface linear velocity of the first charging member to the surface linear velocity of the image carrier at no more than 5:1.

The above-described method may further include maintaining the alternating current voltage with a peak-to-peak voltage within a range of from approximately 500V to approximately 1300V.

The above-described method may further include controlling a charge nip to have a length of 0.5 mm or greater in a surface moving direction of the first charging member.

The above-described method may further include continuously rotating the image carrier including a cylinder-shaped member with a diameter of 20 mm or greater.

The above-described method may further include charging the image carrier before the applying the second charge bias to uniformly charge the surface of the image carrier, and applying a charge bias including at least a direct current voltage for the charging.

The above-described method may further include transferring the image formed on the image carrier onto a recording medium, and moving residual toner remaining on the image carrier from the image carrier to a developer carrier.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic configuration of an image forming apparatus according to an exemplary embodiment of the present invention;

FIG. 2 is an enlarged view of a process unit included in the image forming apparatus of FIG. 1;

FIG. 3 is an enlarged view of a process unit according to a modified exemplary embodiment of the present invention;

FIG. 4 is an enlarged view of a process unit according to a different modified exemplary embodiment of the present invention;

FIG. 5 is an enlarged view of a process unit according to a different modified exemplary embodiment of the present invention;

FIG. 6 is a schematic structure of multiple fibrous members mounted on a rotary shaft member for a black color perpendicular to a surface of the rotary shaft member;

FIG. 7 is a schematic structure of multiple fibrous members mounted on a rotary shaft member in a slanted manner; and

FIG. 8 is an enlarged view of a process unit according to an exemplary embodiment of the present invention.

### DETAILED DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, preferred embodiments of the present invention are described.

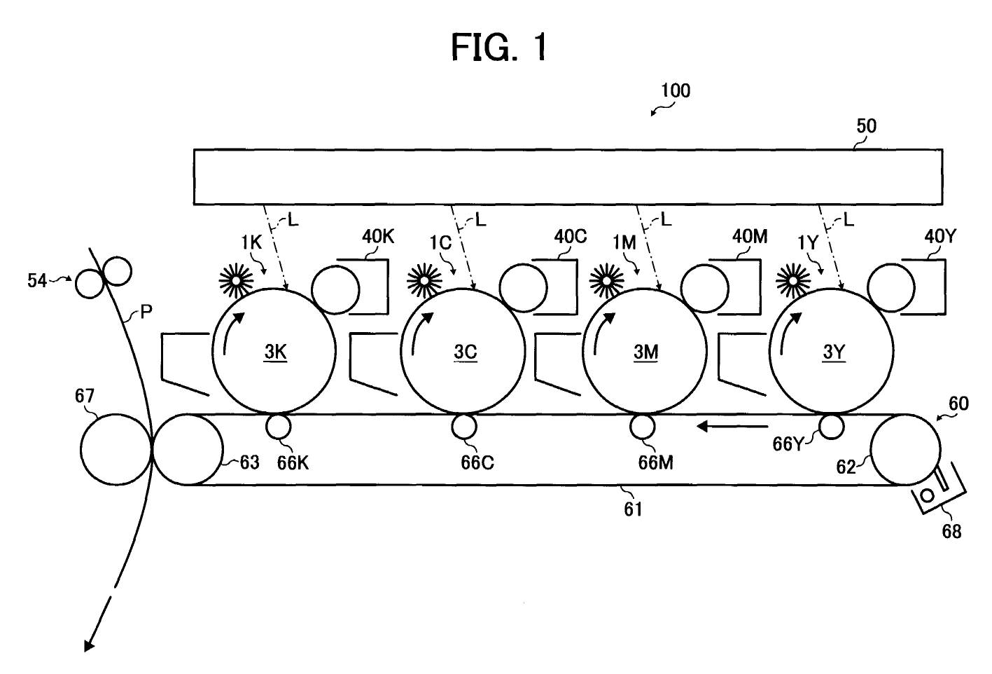

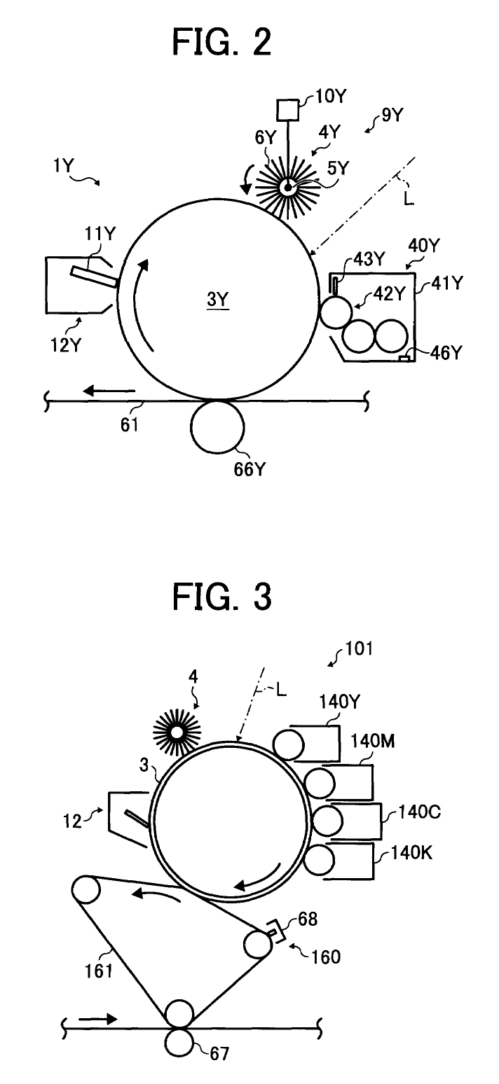

Referring to FIGS. 1 and 2, a description is given of an electrophotographic color laser printer 100 according to an exemplary embodiment of the present invention.

FIG. 1 shows a schematic configuration of the electrophotographic color laser printer 100.

The electrophotographic color laser printer 100 serves as an image forming apparatus according to an exemplary embodiment of the present invention.

Hereinafter, the electrophotographic color laser printer 100 is referred to as a “printer 100.”

In FIG. 1, the printer 100 includes four process units 1Y, 1M, 1C, and 1K, an optical writing unit 50, a pair of registration rollers 54, and a transfer unit 60.

The four process units 1Y, 1M, 1C, and 1K are cartridge type units and can integrally include image forming components therein for forming corresponding color toner images. The process units 1Y, 1M, 1C, and 1K include respective colors of toners, for example, yellow (Y), magenta (M), cyan (C), and black (K).

The suffixes provided to respective components are for indicating the color of toner used therefor.

The optical writing unit 50 includes light sources including four laser diodes for yellow, magenta, cyan, and black toner images, a polygon mirror, a polygon motor for rotating the polygon mirror, f-theta lens, other lenses, reflection mirrors, and so forth.

Respective laser light beams L that are emitted by the above-described laser diodes of the optical writing unit 50 reflect on one of the surfaces of the polygon mirror. The reflected laser light beams L are deflected according to rotations of the polygon mirror and reach a corresponding one of four photoconductor drums 3Y, 3M, 3C, and 3K, which will be described below. The laser light beams L emitted by the laser diodes of the optical writing unit 50 may expose respective surfaces of the four photoconductor drums 3Y, 3M, 3C, and 3K.

The process units 1Y, 1M, 1C, and 1K include drum-shaped photoconductors 3Y, 3M, 3C, and 3K that serve as image carrier, developing units 40Y, 40M, 40C, and 40K corresponding to the respective photoconductors 3Y, 3M, 3C, and 3K, and so forth.

The photoconductors 3Y, 3M, 3C, and 3K include a raw tube e.g., an aluminum tube, covered by an organic photoconductive layer. The photoconductor 3Y, 3M, 3C, and 3K are rotated by respective photoconductor drive units, not shown, at a predetermined linear velocity in a clockwise direction in FIG. 1. Then, based on image data that is sent from a personal computer, not shown, the optical writing unit 50 emits the modulated laser light beams L to irradiate the photoconductors 3Y, 3M, 3C, and 3K for forming respective electrostatic latent images.

FIG. 2 shows a schematic configuration of the process unit 1Y for forming yellow toner images, together with the transfer unit 60 and an intermediate transfer belt 61 included in the transfer unit 60.

Since the four process units 1Y, 1M, 1C, and 1K have the structure and function identical to each other, FIG. 2 is focused on the process unit 1Y for yellow toner images.

In FIG. 2, the process unit 1Y for yellow toner images includes the photoconductor 3Y, a charging brush roller 4Y, a discharge lamp, not shown, the developing unit 40Y, and other image forming components. The above-described image forming components are integrally mounted to a common unit casing or housing to be detachable with respect to a main body of the printer 100.

The photoconductor 3Y serves as an image carrier for carrying an electrostatic latent image for yellow toner image, and is a target member to be charged by the charging unit 9Y that includes the charging brush roller 4Y for charging the surface of the photoconductor 3Y.

The photoconductor 3Y includes a drum-shaped or cylinder-shaped member having a diameter of 24 mm, for example. Specifically, the photoconductor 3Y has a conductive base member including an aluminum tube and a photoconductive layer including negative electric organic photoconductor (OPC) covered around the conductive base member. The photoconductor 3Y is rotated by a photoconductor drive unit, not shown, at a given linear velocity in a clockwise direction in FIG. 2.

The charging brush roller 4Y of FIG. 2 includes a rotary shaft member 5Y, and multiple conductive fibrous members 6Y.

The rotary shaft member 5Y and the multiple conductive fibrous members 6Y form the charging brush roller 4Y that serves as a first charging member.

The rotary shaft member 5Y is formed by a metallic material that can be rotatably born by a bearing, not shown.

The multiple conductive fibrous members 6Y are arranged perpendicular to a circumferential surface of the rotary shaft member 5Y.

While a charge member drive unit, not shown, rotates the charging brush roller 4Y about an axis of the rotary shaft member 5Y in a counterclockwise direction in FIG. 2, respective tips of the multiple conductive fibrous members 6Y slidably contact the surface of the photoconductor 3Y.

The rotary shaft member 5Y is connected to a charge bias applying unit 10Y including a power source, not shown, and wires, not shown, so that a charge bias that includes an AC bias voltage superimposed on a DC bias voltage can be applied to the charging brush roller 4Y.

Specifically, the charging brush roller 4Y, the charging member drive unit, not shown, for driving the charging brush roller 4Y, and the charge bias applying unit 10Y form a charging system of the printer 100 so that the surface of the photoconductor 3Y can be uniformly charged. The printer 100 is controlled to discharge between the multiple conductive fibrous members 6Y of the charging brush roller 4Y and the photoconductor 3Y and uniformly charge the surface of the photoconductor 3Y to a negative polarity.

In the above-described charging system, the charging brush roller 4Y may integrally be provided with the photoconductor 3Y and so forth in the process unit 1Y and can be attached to or detached from the main body of the printer 100.

On the uniformly charged surface of the photoconductor 3Y for yellow toner image, the above-described optical writing unit 50 optically scans and forms an electrostatic latent image for a yellow toner image on the surface of the photoconductor 3Y. The electrostatic latent image for yellow color is developed into a yellow toner image by the developing unit 40Y.

The developing unit 40Y for developing yellow color images includes a casing 41Y and a developing roller 42Y.

The developing roller 42Y is disposed exposing a part of its surface through an opening arranged on the casing 41Y. The developing roller 42Y includes a developing sleeve formed by a non-magnetic pipe that is rotated by a drive unit, not shown, and a magnet roller, not shown, that is arranged in a hollow portion of the developing sleeve and is controlled not to be rotated with the developing sleeve.

The casing 41Y accommodates yellow developer, not shown, including magnetic carriers and yellow toner for negative charging.

While being agitated by an agitating and conveying unit including two screw members in a direction perpendicular to a face of the drawing and frictionally charged to a negative polarity, the yellow toner is attracted by a magnetic force of the magnet roller of the developing roller 42Y in rotation and conveyed to a surface of the developing sleeve. When the yellow toner on the developing sleeve passes a position opposite to a development doctor 43Y according to rotations of the developing roller 42Y, the development doctor 43Y may regulate the layer thickness of the yellow toner. After the regulation of the layer thickness has been conducted, the yellow toner is conveyed to an image formation region opposite to the photoconductor 3Y.

In the image formation region, a development potential is provided between the developing sleeve to which a negative development bias is output from a power source, not shown, and the electrostatic latent image formed on the photoconductor 3Y. The development potential may cause an action of electrostatically transferring the negatively charged yellow toner from the developing sleeve to the electrostatic latent image on the photoconductor 3Y. In addition, a non-development potential is provided between the developing sleeve and a uniformly charged portion or background portion of the photoconductor 3Y so that the non-development potential may cause an action of electrostatically transferring the negatively charged yellow toner from the background portion to the developing sleeve.

By the action of the development potential, the yellow toner on the developing sleeve may be transferred from the developing sleeve to the electrostatic latent image on the photoconductor 3Y. According to this transfer, the electrostatic latent image is developed into a yellow toner image.

According to the development of the yellow toner image, the developer for yellow color may contain a lesser amount of yellow toner. Such developer for yellow color is returned to the casing 41Y as the development sleeve rotates. In addition, the yellow toner image on the photoconductor 3Y is transferred onto the intermediate transfer belt 61 of the transfer unit 60, which is later described.

A toner density sensor 46Y includes a permeability sensor and is fixedly mounted on a bottom plate of the casing 41Y so as to output a voltage according to the magnetic permeability of the developer for yellow color accommodated in the casing 41Y.

The magnetic permeability of the developer for yellow color shows a preferable relation with respect to the toner density of the developer. Therefore, the toner density sensor 46Y may output a voltage according to the density of yellow toner. The value of this output voltage is sent to a toner supply control unit, not shown.

The toner supply control unit includes a storing unit such as a random access memory or RAM so as to store Vtref for yellow toner, which is a target voltage value output from the toner density sensor 46Y, as well as other Vtref data for magenta, cyan, and black toners obtained in the same way as the Vtref for yellow toner.

The developing unit 40Y for yellow toner compares the voltage value output by the toner density sensor 46Y and Vtref for yellow toner. Then, the developing unit 40Y may cause a yellow toner density control unit (not shown) to drive by a period of time according to the result of the comparison and supply additional yellow toner into the developing unit 40Y.

By controlling the yellow toner density control unit as described above, an appropriate amount of yellow toner may be supplied to the developer having the less yellow toner density so that the yellow toner density in the developer in the developing unit 40Y can be maintained within its given range.

The same toner density control may be conducted for the other developing units of magenta, cyan, and black.

In an exemplary embodiment of the present invention, the developing unit 40Y accommodates a two-component developer including toner and magnetic carrier. However, a developing unit that can be used for the present invention is not limited to the developing unit 40Y for the two-component developer. Alternatively, a developing unit that accommodates a one-component developer mainly including toner can be applied to the present invention.

A yellow toner image formed on the photoconductor 3Y may be transferred onto the intermediate transfer belt 61 at a primary transfer nip at which the photoconductor 3Y and the intermediate transfer belt 61 contact to each other.

After passing through the primary transfer nip, the photoconductor 3Y may still hold residual toner that has not been transferred onto the intermediate transfer belt 61.

To remove the residual toner, the process unit 1Y includes a drum cleaning unit 12Y and a cleaning blade 11Y.

The drum cleaning unit 12Y uses the cleaning blade 11Y to scrape the residual toner from the surface of the photoconductor 3Y.

Each of the multiple fibrous members 6Y of the charging brush roller 4Y is a conductive fiber that is cut to a given length.

Examples of possible materials for the conductive fiber are resin materials, for example, NYLON6 (registered trademark), NYLON12 (registered trademark), acrylic resin, vinylon resin, polyester resin, etc. Conducting particles such as carbon or metallic fine powder are dispersed to the above-described resin material to make the fibers conductive.

By taking account of production costs and low Young's modulus, it is preferable to use a conductive fiber made of nylon resin with carbon being dispersed thereto. Carbon may be unevenly distributed in the fiber.

Examples of possible materials for the rotary shaft member 5Y on which the multiple fibrous members 6Y are mounted perpendicular to the surface of the rotary shaft member 5Y are stainless steel, which are SUS303, SUS304, SUS316, SUS416, SUS420, SUS430, and so forth. Free-cutting steel, which are SUM22, SUM23, SUM23L, SUM24L, and so forth, or these materials having a plated surface can also be used.

By taking account of production costs and safeness (excluding lead material), it is preferable to use a member made of SUM22 or SUM23 having a plated surface.

As described above, the process unit 1Y may be operated to form a yellow toner image.

As previously described, the other process units 1M, 1C, and 1K have basically the same functions and structures as the process unit 1Y, except for different toner colors. Therefore, description of the operations of the other process units 1M, 1C, and 1K are omitted.

As shown in FIG. 1, the transfer unit 60 is disposed below and adjacent to the process units 1Y, 1M, 1C, and 1K.

The transfer unit 60 includes the intermediate transfer belt 61, a driven roller 62, a drive roller 63, and four primary transfer bias rollers 66Y, 66M, 66C, and 66K.

The intermediate transfer belt 61 is formed of an endless-shaped belt member and rotates in a counterclockwise direction in FIG. 1. The intermediate transfer belt 61 is extended by and spanned around the driven roller 62, the drive roller 63, and the primary transfer bias rollers 66Y, 66M, 66C, and 66K.

The driven roller 62, the drive roller 63, and the primary transfer bias rollers 66Y, 66M, 66C, and 66K are held in contact with an inner surface of the intermediate transfer belt 61.

The four primary transfer bias rollers 66Y, 66M, 66C, and 66K are rollers, each of which includes a metallic cored bar covered by an elastic material such as sponge. The four primary transfer bias rollers 66Y, 66M, 66C, and 66K are in press contact with the photoconductor drums 3Y, 3M, 3C, and 3K, respectively, while sandwiching the intermediate transfer belt 61 therebetween. At respective positions at which the photoconductor drums 3Y, 3M, 3C, and 3K and the intermediate transfer belt 61 contact at given intervals in a belt moving direction, four primary transfer nips for forming respective single color toner image of different colors may be formed.

A primary transfer bias controlled by respective transfer bias power sources, not shown, to flow a constant current is applied to the cored bars of the primary transfer bias rollers 66Y, 66M, 66C, and 66K. By so doing, a transfer charge can be provided via the primary transfer bias rollers 66Y, 66M, 66C, and 66K to the inner surface of the intermediate transfer belt 61 so that respective electric fields for transfer can be formed at the primary transfer nips formed between the intermediate transfer belt 61 and the photoconductor drums 3Y, 3M, 3C, and 3K.

In an exemplary embodiment of the present invention, the printer 100 includes a roller-shaped member, i.e., the primary transfer bias rollers 66Y, 66M, 66C, and 66K, as a primary transfer member. However, the shape of the primary transfer member is not limited to the above-described roller-shaped member. Alternatively, a brush-type member, blade-type member, or a transfer charger may be applied to the present invention.

The different single color toner images, which are yellow toner image, magenta toner image, cyan toner image, and black toner image, formed on the respective photoconductors 3Y, 3M, 3C, and 3K may be transferred onto the intermediate transfer belt 61 at the respective primary transfer nips in an overlaying manner, so that a four color overlaid toner image (hereinafter, referred to as an “overlaid toner image” or “toner image”) can be formed on the intermediate transfer belt 61.

At a position at which the drive roller 63 is held in contact with the intermediate transfer belt 61, a secondary transfer bias roller 67 is disposed in a manner contacting the opposite surface or outer surface of the intermediate transfer belt 61. That is, the driven roller 63 and the secondary transfer bias roller 67 are held in contact with each other by sandwiching the intermediate transfer belt 61, thereby forming a secondary transfer nip.

A secondary transfer bias is applied to the secondary transfer bias roller 67 by a voltage applying unit, not shown, which includes a power source and wiring. Thereby, an electric field for the secondary transfer can be formed between the secondary transfer bias roller 67 and the driven roller 63. The overlaid toner image formed on the intermediate transfer belt 61 comes to the secondary transfer nip according to the rotations of the intermediate transfer belt 61.

The printer 100 further includes a sheet feeding cassette, not shown, to accommodate recording media or multiple recording papers therein. The sheet feeding cassette feeds a recording paper P placed on top of the recording media accommodated therein to a sheet feeding path at a given timing.

The recording paper P fed from the sheet feeding cassette travels in the sheet feeding path and reaches a pair of registration rollers 54 disposed at a far end of the sheet feeding path, at which the recording paper P is stopped and sandwiched by the pair of registration rollers 54.

The pair of registration rollers 54 rotates to receive the recording paper P from the sheet feeding cassette and sandwich the recording paper P at a registration nip formed therebetween. Upon sandwiching the leading edge of the recording paper P, the pair of registration rollers 54 stops its rotation. Then, the pair of registration rollers 54 feeds the recording paper P toward the secondary transfer nip in synchronization with a movement of the overlaid toner image formed on the intermediate transfer belt 61.

At the secondary transfer nip, the overlaid toner image on the intermediate transfer belt 61 is secondarily transferred onto the recording paper P by action of the electric field of the secondary transfer and the nip pressure. On the recording paper P, the overlaid toner image is combined with a white color of the recording paper P, resulting in a formation of a full-color image.

The recording paper P with the full-color toner image thereon passes through the secondary transfer nip and comes to a fixing unit, not shown, so as to fix the full-color toner image onto the recording paper P.

After the overlaid toner image has transferred onto the recording paper P, residual toner remaining on the surface of the intermediate transfer belt 61 may be removed by a belt cleaning unit 68.

As described above, with the basic structure of the printer 100 according to the exemplary embodiment of the present invention, the photoconductors 3Y, 3M, 3C, and 3K perform as an image carrier for carrying an electrostatic latent image on the surface that continuously rotates. The optical writing unit 50 performs as a latent image forming unit for forming an electrostatic latent image onto the respective charged surfaces of the photoconductors 3Y, 3M, 3C, and 3K serving as latent image carrier.

In addition, a driving source such as motor and a drive transmission member such as gear drive the photoconductors 3Y, 3M, 3C, and 3K to rotate continuously. Further, a drive controller, not shown, includes a control circuit having a known central processing unit or CPU and an information storing unit having a random access memory or RAM and controls the switching action (on and off) of the driving source. The driving source, the drive transmission member, and the drive controller may serve as an electrostatic latent image control unit.

Next, processes and results of the tests performed by the inventors of the present invention are described.

[Test 1]

The inventors prepared a test machine having the same configuration of the printer 100 of FIGS. 1 and 2 according to an exemplary embodiment of the present invention.

The inventors conducted the tests with the above-described test machine by changing conditions of charge bias, linear velocities of a photoconductor and a charging brush roller, and so forth. Under the different conditions and linear velocities of the above-described parameters, a monochrome halftone chart was copied with a 5% image area ratio to A4-size paper to obtain multiple reproduced halftone images. The inventors magnified and observed the reproduced halftone images and the photoconductor drum. Based on the results of the above-observation, the inventors evaluated the occurrences of charging non-uniformity and filming on photoconductors.

For the charging non-uniformity, the inventors ranked the evaluated reproduced halftone images based on the occurrence frequency of white streaks or black streaks that appeared in the horizontal direction or main-scanning direction in the halftone images. The charging non-uniformity on photoconductor was evaluated in a four-grade evaluation system as follows:

Rank 1: Occurrence of charging non-uniformity is significantly observed;

Rank 2: Occurrence of charging non-uniformity is slightly observed but not adversely affected on images;

Rank 3: Occurrence of charging non-uniformity is not adversely affected on two-by-two halftone images; and

Rank 4: Occurrence of charging non-uniformity is not adversely affected on one-by-one halftone images.

Rank 1 was evaluated as “POOR” indicating the level of occurrence frequency can affect the reproduction of images, and ranks 2, 3, and 4 were evaluated as “GOOD” indicating the level of occurrence frequency is acceptable and may be not affect the reproduction of images.

For the filming, the inventors ranked the evaluated reproduced halftone images based on the occurrence frequency of black streaks or streaks that appeared in the vertical direction or sub-scanning direction in the halftone images. The filming was evaluated in a four-grade evaluation system as follows:

Rank 1: Occurrence of filming is significantly observed;

Rank 2: Occurrence of filming is slightly observed but not adversely affected on images;

Rank 3: Occurrence of filming is not adversely affected on two-by-two halftone images; and

Rank 4: Occurrence of filming is not adversely affected on one-by-one halftone images.

As previously described for the ranks of charging non-uniformity, rank 1 was evaluated as “POOR” indicating the level can affect the reproduction of images, and ranks 2, 3, and 4 were evaluated as “GOOD” indicating the level is acceptable and may be not affect the reproduction of images.

Numbers before and after “by” in “one-by-one” and “two-by-two” are the minimum distance between dots indicating the type of a halftone chart. For example, when a one-by-one halftone image that renders halftone in a one-by-one method, the minimum distance between dots corresponds to 2 dot lengths. When a two-by-two halftone image that renders halftone in a two-by-two method, the minimum distance between dots corresponds to 4 dot lengths.

A charge bias to be applied to a charging brush roller, i.e., the charging brush roller 4Y, includes an alternating current or AC bias voltage superimposed on a direct current or DC bias voltage and a 50% duty. Specifically, the AC bias voltage includes a peak-to-peak voltage Vpp of 1.0 kV, and the DC bias voltage includes a direct voltage Vdc of −500V.

Further, a charge nip is formed between the charging brush roller, i.e., the charging brush roller 4Y, and a photoconductor, i.e., the photoconductor 3Y, when the leading edge of the charging brush roller 4Y contacts the photoconductor 3Y. A size of the charge nip in a photoconductor surface moving direction, which corresponds to a brush surface moving direction, was set to 1.0 mm.

A charging brush roller corresponding to the charging brush roller 4Y includes multiple fibrous members, each having a volume resistivity of approximately 10⁸Ω·cm, a material of nylon fiber including conducting particles, and a length of 3 mm. The above-described multiple fibrous members are mounted on a rotary shaft member, i.e., the rotary shaft member 5Y, having a diameter of 5 mm straightly perpendicular to a surface of a rotary shaft member, so that the charging brush roller 4Y may be made as a roller having a diameter of 11 mm.

A drum-shaped photoconductor corresponding to the photoconductor 3Y includes a diameter of 24 mm.

Table 1 shows the results of the tests conducted under the above-described conditions.

TABLE 1

| | | | | | | Filming | |
|---|---|---|---|---|---|---|---|
| | Linear | | | | | with | |
| | Veloc- | Linear | Bias | | Initial | output | |
| | ity | Velocity | Fre- | | Charging | of | |
| Test | Ratio | V1 | quency | | Non- | 10000 | |
| No. | (V2/V1) | [mm/sec] | f [Hz] | f/V1 | uniformity | sheets | Rank |
| 1 | 1.5:1 | 100 | 50 | 0.5 | 1 | — | 1 |
| 2 | | | 150 | 1.5 | 1 | — | 1 |
| 3 | | | 400 | 4.0 | 3 | 1 | 1 |
| 4 | | | 500 | 5.0 | 3 | 1 | 1 |
| 5 | | 150 | 100 | 0.7 | 1 | — | 1 |
| 6 | | | 200 | 1.3 | 1 | — | 1 |
| 7 | | | 600 | 4.0 | 3 | 1 | 1 |
| 8 | | | 800 | 5.3 | 3 | 1 | 1 |
| 9 | 2:1 | 100 | 50 | 0.5 | 1 | — | 1 |
| 10 | | | 150 | 1.5 | 4 | 4 | 4 |
| 11 | | | 400 | 4.0 | 3 | 3 | 3 |
| 12 | | | 500 | 5.0 | 3 | 1 | 1 |
| 13 | | 150 | 100 | 0.7 | 1 | — | 1 |
| 14 | | | 200 | 1.3 | 1 | 3 | 1 |
| 15 | | | 220 | 1.5 | 3 | 3 | 3 |
| 16 | | | 600 | 4.0 | 3 | 3 | 3 |
| 17 | | | 800 | 5.3 | 3 | 1 | 1 |

As shown in Table 1, under the condition that the linear velocity ratio (V2/V1) that is a ratio of the linear velocity “V1” [mm/sec] of the photoconductor 3Y to the linear velocity “V2” [mm/sec] of the charging brush roller 4Y is set to 1.5:1, the occurrence level of one of the charging non-uniformity and filming was resulted in Rank 1, regardless the other parameters of the condition.

By contrast, under the conduction that the linear velocity ratio (V2/V1) is set to 2:1, both of the charging non-uniformity and filming reached the respective occurrence levels that satisfy the standard depending on the other parameters of the condition, and were resulted in any one of Ranks 2, 3, and 4.

Details of the results obtained under the condition that the linear velocity ratio (V2/V1) is set to 2:1 are described below.

When a ratio of the frequency “f” of the AC voltage of the charge bias from the charging brush roller 4Y to the linear velocity “V1” of the photoconductor 3Y is equal to or greater than 5:1, that is, when a ratio of the frequency “f” to the linear velocity “V1” is relatively high, the reproduction of 10,000 copies of a halftone chart can cause significant filming on the reproduced halftone images.

It is known that the charging non-uniformity of a photoconductor can be reduced or prevented, where possible, when setting a relatively high ratio of the frequency “f” to the linear velocity “V1” of the photoconductor 3Y. However, when a ratio of the frequency “f” to the linear velocity “V1” is smaller than 4:1, that is, when a ratio of the frequency “f” to the linear velocity “V1” is relatively low, the occurrence level of filming could remain within the allowable range after the reproduction of 10,000 copies of a halftone chart.

Here, it is noteworthy about the relationship of the frequency “f” to the linear velocity “V1”, the linear velocity ratio (V2/V1) (with the ratio of 2:1), and the occurrence of charging non-uniformity on photoconductor.

In a known charging system, a charging brush roller is generally rotated following a photoconductor while the charging brush roller is held in contact with the photoconductor. In this case, the linear velocity ratio of the charging brush roller to the photoconductor is 1.0. Under the above-described condition, a ratio of the frequency “f” to the linear velocity “V1” may need to be set greater than 4:1, otherwise, the charging non-uniformity can occur.

However, as shown in Table 1, the above-described tests, i.e., Test Nos. 10 and 15, showed that some occurrence levels of the charging non-uniformity stayed within the allowable range even when a ratio of the frequency “f” to the linear velocity “V1” is set equal to or smaller than 4:1. The reason why the above-described results were obtained is believed that the linear velocity ratio was set to 2:1 to move the surface of the charging brush roller at the charge nip at a speed two times greater than the surface of the photoconductor, and therefore, a sufficient number of electrical discharge was made even under the condition that the frequency “f” was relatively low. Specifically, electric charge is generally caused at an upstream side in the brush surface moving direction of the charge nip. However, by causing the surface of the charging brush roller at the charge nip to move at a speed two times greater than the surface of the photoconductor, electrical discharge was caused even at a middle or downstream side of the charge nip, and therefore, the photoconductor drum could uniformly be charged. That is, the above-described tests have confirmed that the charging non-uniformity can be reduced or prevented, even under the condition that a ratio of the frequency “f” to the linear velocity “V1” is 4:1 when the linear velocity ratio is equal to or greater than 2:1.

Furthermore, the frequency “f” to the linear velocity “V1” of the photoconductor was relatively low under the above-described condition. Therefore, the occurrence level of filming can remain within the allowable range, as described above. However, when a ratio of the frequency “f” to the linear velocity “V1” was equal to or smaller than 1.5:1, the charging non-uniformity occurred even when the linear velocity ratio was set to 2:1. The reason why the above-described result was obtained is believed that, since the frequency “f” to the linear velocity “V1” was too small, the number of electrical discharge between the photoconductor and the charging brush roller was insufficient.

In light of the above-described results of the tests conducted by the inventors of the present invention, the printer 100 according to an exemplary embodiment of the present invention is provided with the charge bias applying unit 10Y that includes a power source and wires, not shown, and applies a charge bias to the charging brush roller 4Y, and the charge bias applying unit 10Y may be controlled to have a ratio of the frequency “f” to the linear velocity “V1” within a range of from approximately 1.5:1 to approximately 4:1.

Further, the printer 100 combines the function of a photoconductor drive unit including motor and gears for driving the photoconductor, e.g., the photoconductors 3Y, 3M, 3C, and 3K, and a brush drive unit including motor and gears for driving the charging brush roller, e.g., the charging brush roller 4Y. The combined unit may be controlled to have the linear velocity ratio (V2/V1) of 2 or greater.

Further, according to the results shown in Table 1, the occurrence of filming becomes frequent as the ratio of frequency “f” to the linear velocity “V1” increases. Filming may also be caused due to the width of charge nip, the diameter of photoconductor, and so forth, in addition to the frequency “f” to the linear velocity “V1”. Specifically, as the width of charge nip becomes smaller, the amount of electrical discharge per unit area of the photoconductor 3Y increases, thereby causing filming more frequently. In addition, as the diameter of the photoconductor 3Y decreases, the charging brush roller 4Y contacts the photoconductor 3Y more often, thereby causing filming more frequently.

[Test 2]

In response to the above-described results, the inventors of the present invention conducted a further test to evaluate the filming. The test was conducted under mixed conditions that were relatively adverse conditions in the given range of “f/V1”, the frequency “f” to the linear velocity “V1”, within the range of from approximately 1.5:1 to approximately 4:1. Specifically, the mixed conditions included the condition that a ratio of the frequency “f” to the linear velocity “V1” is set to 4:1, which was the most adverse condition against the filming, the condition that the charge nip width is set to a relatively small value, which was a relatively less adverse condition against the filming, and the condition that the diameter of the photoconductor drum is set to a relatively small value, which was a relatively less adverse condition against the filming. As a result, the inventors found that, even under the conditions that the frequency “f” to the linear velocity “V1” was 4, the charge nip width was 0.5 mm, and the diameter of the photoconductor drum was 20 mm, when 10,000 copies of a halftone chart were reproduced and output, the results of the test on the filming could avoid Rank 1 and fell in Rank 2, which indicated that the occurrence of filming was slightly observed but not adversely affect on images.

[Test 3]

The inventors then replaced the charging brush roller 4Y with a charging roller having a bow-shaped circumferential surface, and changed the parameters such that the frequency “f” to the linear velocity “V1” was set to 1.5:1 and the linear velocity ratio (V2/V1) was set to 2:1. Under the above-described conditions, the inventors evaluated the occurrence of charging non-uniformity on photoconductor. As a result, the inventors found that, under the above-described conditions, the occurrence frequency of the charging non-uniformity on photoconductor was resulted in Rank 2, indicating that the occurrence of charging non-uniformity was slightly observed but not adversely affected on images.

[Test 4]

As described above, the linear velocity ratio (V2/V1) may need to be set to equal to or greater than 2:1. However, when the linear velocity ratio (V2/V1) is set to significantly greater than 2:1, the charging brush roller 4Y and the photoconductor 3Y may rub against each other, and cause significant abrasion on the surface of the photoconductor 3Y.

According to the test result conducted by the inventors of the present invention, the inventors found that, when the linear velocity ratio (V2/V1) was set to greater than 5:1, the photoconductor 3Y was damaged by abrasion or wearing-off to deteriorate the surface thereof. As a result, due to the deterioration caused by the above-described damage, the photoconductor 3Y cannot have a usable life enough to reproduce 10,000 copies of a halftone chart in good or acceptable image quality.

Accordingly, in the printer 100 according to an exemplary embodiment of the present invention, the linear velocity ratio (V2/V1) is controlled to be set to 5 or smaller.

[Test 5]

It is preferable to set the linear velocity “V2” of the charging brush roller 4Y to smaller than 250 mm/sec.

The inventors of the present invention found and confirmed through the tests that, when the linear velocity “V2” was set to 250 mm/sec or greater, the amount of toner scattering from the brush rapidly increased.

The charging non-uniformity evaluated as shown in Table 1 was caused when the frequency “f” was significantly low. Specifically, for example, the charging brush roller 4Y applies a charge bias including an AC component having the peak-to-peak voltage Vpp of 1000V superimposed on a DC component of −500V. While the electrically discharged surface of the photoconductor 3Y is passing a contact position with the charging brush roller 4Y, the photoconductor 3Y can sufficiently be charged when the AC component of the charge bias reaches a peak on the minus side and the photoconductor 3Y cannot be charged enough when the AC component of the charge bias reaches a peak on the plus side.

When the frequency “f” is relatively high, the length of an insufficiently charged area in the photoconductor moving direction is relatively small or short. Therefore, it may be unclear that the insufficiently charged area and a sufficiently charged area have a difference in density or has density non-uniformity. Accordingly, it is almost difficult to find white streaks and/or black streams presenting along a horizontal direction of a reproduced image.

On the other hand, when the frequency “f” is relatively low, the length of the insufficiently charged area becomes too great. Therefore, the presence of white streaks and/or black streams can become strongly apparent.

In an electrophotographic image forming apparatus, in addition to the occurrence of the above-described charging non-uniformity, local charging non-uniformity may be caused when the peak-to-peak voltage Vpp of the AC component of the charge bias is too great. Specifically, for example, the charging brush roller 4Y applies a charge bias including an AC component having the peak-to-peak voltage Vpp of 1000V superimposed on a DC component of −500V. In this case, as long as the frequency “f” of the AC component is set to an appropriate value, the photoconductor 3Y may be charged around a timing that the AC component of the charge bias reaches a peak on the minus side and the photoconductor 3Y may be electrically discharged around a timing that the AC component of the charge bias reaches a peak on the plus side. According to vibration of the alternating electric field, the above-described charging operation and discharging operation are repeated.

However, the duty of the AC component and the duty of the DC component may be different, and the duty of the AC component may be 50% or greater. According to the different allocation of time for the charging operation and discharging operation, the photoconductor 3Y may eventually be charged to a potential between the peak voltage of the minus side and the peak voltage of the plus side.

However, when the peak-to-peak voltage Vpp is too small, a local area on which a sufficient amount of electric charge cannot be obtained due to variation of electrical resistance (impedance) of brush may be produced at the contact portion of the photoconductor 3Y and the charging brush roller 4Y. (The discharge inception voltage according to Paschen's law is within a range of from approximately 400V to approximately 600V.) Such local area may become less charged and generate white spots on images.

When the peak-to-peak voltage Vpp is too great, a local area on which an extra amount of electrical discharge may be caused due to variation of electrical resistance (impedance) of brush may be produced at the contact portion of the photoconductor 3Y and the charging brush roller 4Y. Such local area may become overcharged and generate black spots on images.

[Test 6]

The inventors of the present invention then reproduced and output copies of a halftone chart while changing the values of the peak-to-peak voltage Vpp of the AC component. Under the above-described conditions, the inventors evaluated the occurrence of white spots and black spots due to local charging non-uniformity.

As a result, the inventors found that white spots rapidly started to appear when the peak-to-peak voltage Vpp decreased below 500V and black spots rapidly started to appear when the peak-to-peak voltage Vpp increased above 1300V.

In light of the above-described tests, the peak-to-peak voltage Vpp of the printer 100 according to an exemplary embodiment of the present invention is controlled to be set within a range of from approximately 500V to approximately 1300V.

As described above, the present invention can be applied to a tandem-type color printer in which toner images formed by multiple process units are sequentially transferred to form a full color image and superimposed onto a recording medium.

The present invention is similarly applicable to a single-type color image forming apparatus in which multiple developing units for different colors of toner are disposed around a single photoconductor drum such as an electrostatic image carrying member and sequentially switched to form each toner image on the single photoconductor so that the overlaid toner image can be transferred onto an intermediate transfer member.

The present invention is also applicable to an image forming apparatus having a monochrome printing method.

Referring to FIG. 3, a schematic structure of a process unit 101 according to a modified exemplary embodiment of the present invention is described.

Different from the process units 1Y, 1M, 1C, and 1K of the tandem-type method, the process unit 101 employs a single-type method.

Elements having the same functions and shapes are denoted by the same reference numerals throughout the specification and redundant descriptions are omitted. Elements that do not require descriptions may be omitted from the drawings as a matter of convenience.

Around a drum-shaped photoconductor 3, four developing units 140Y, 140M, 140C, and 140K for yellow toner, magenta toner, cyan toner, and black toner, respectively, are disposed.

A laser light beam L is emitted to irradiate a surface of the photoconductor 3 to form an electrostatic latent image for yellow color. The developing unit 140Y develops the electrostatic latent image into a visible yellow toner image. After being developed, the yellow toner image is primarily transferred onto an intermediate transfer belt 161 included in a transfer unit 160.

After passing the primary transfer nip formed between the intermediate transfer belt 161 and the photoconductor 3, the surface of the intermediate transfer belt 61 is cleaned by a drum cleaning unit 12 to remove residual toner remaining thereon and is electrically discharged by a discharging lamp, not shown.

The photoconductor 3 is uniformly charged by the charging brush roller 4, and irradiated by the laser light beam L to form an electrostatic latent image for magenta color. The developing unit 140M develops the electrostatic latent image into a visible magenta toner image. Then, the magenta toner image is primarily transferred onto the intermediate transfer belt 61 such that the magenta toner image is overlaid onto the yellow toner image previously transferred onto the intermediate transfer belt 61.

A cyan toner image and a black toner image are formed in a similar manner as the yellow toner image and the magenta toner image described above, except that the cyan toner image is developed by the developing unit 140C and the black toner image is developed by the developing unit 140K.

When the yellow, magenta, cyan, and black toner images are sequentially overlaid, a full color toner image may be formed.

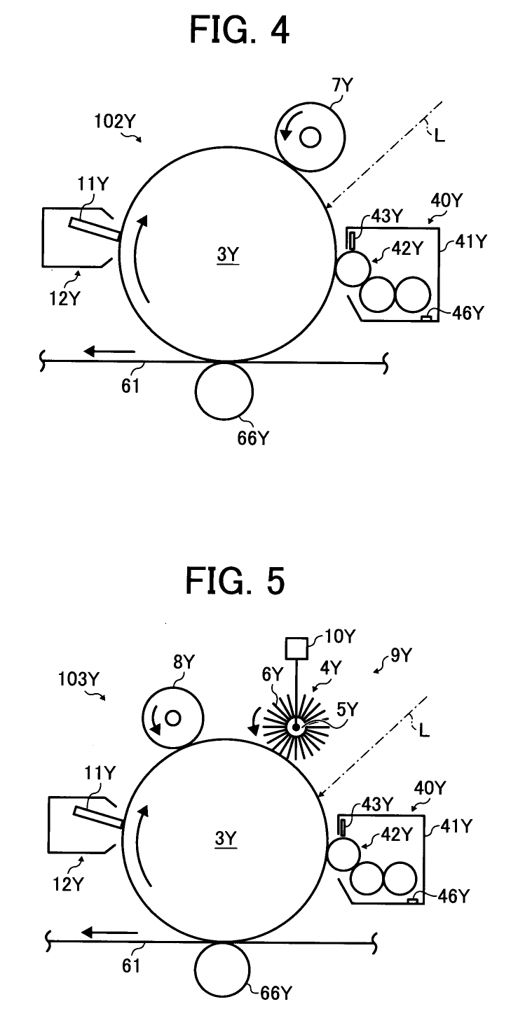

Referring to FIG. 4, a schematic structure of a process unit 102Y according to another modified exemplary embodiment of the present invention is described.

The structure and functions of the process unit 102Y are similar to the structure and functions of the process unit 1Y. Except, the process unit 102Y employs a charge roller 7Y having a circumferential surface that is sequentially curving, instead of the charging brush roller 4Y of the process unit 1Y of FIG. 2.

The charge roller 7Y includes a cored bar (conductive shaft) that has a diameter of 6 mm, covered by a layer made of elastic material, and a roller having a diameter of 12 mm covered by a dielectric layer and a surface layer around the circumference of the elastic layer covering the cored bar. The resistance of the charge roller 7Y is preferably set to approximately 10⁵Ω.

Same as the charging brush roller 4Y, the charge roller 7Y is rotated to move the surface thereof with the surface of the photoconductor 3Y at the charge nip.

Referring to FIG. 5, a schematic structure of a process unit 103Y according to another modified exemplary embodiment of the present invention is described.

The structure and functions of the process unit 103Y are similar to the structure and functions of the process unit 1Y. Except, the process unit 103Y further includes an auxiliary charge roller 8Y serving as a second charging member.

The auxiliary charge roller 8Y is disposed at an upstream side of a contact position of the photoconductor 3Y and the charging brush roller 4Y in the surface moving direction of the photoconductor 3Y and at a downstream side of a contact position of the photoconductor 3Y and the cleaning blade 11Y in the surface moving direction of the photoconductor 3Y.

The charge bias applying unit 10Y including a power source and wires, not shown, of the charging unit 9Y applies a charge bias including an AC voltage superimposed on a DC voltage, to the charging brush roller 4Y. By contrast, the charge bias applying unit 10Y applies an auxiliary charge bias including a DC voltage only, to the auxiliary charge roller 8Y.

With the above-described structure, abrasion associated with the discharge from the charging brush roller 4Y can be reduced, thereby providing a longer life to the charging brush roller 4Y. Specifically, prior to the charging operation performed by the charging brush roller 4Y, the photoconductor 3Y can be charged in reserve by the auxiliary charge roller 8Y to a given amount. As a result, compared with the process unit 1Y, for example, which is not provided with the auxiliary charge roller 8Y, the process unit 103Y can reduce the amount of discharge at the charge nip formed between the charging brush roller 4Y and the photoconductor 3Y, thereby reducing the level of abrasion of the charging brush roller 4Y.

Next, a description is given of further details of the printer 100 according to an exemplary embodiment of the present invention. Elements having the same functions and shapes are denoted by the same reference numerals throughout the specification and redundant descriptions are omitted. Elements that do not require descriptions may be omitted from the drawings as a matter of convenience.

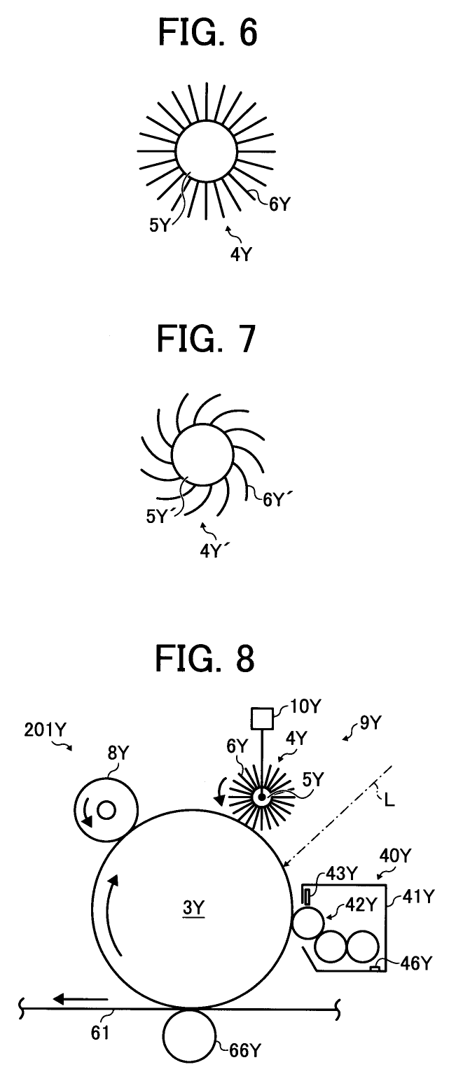

Referring to FIGS. 6 and 7, schematic structures of the charging brush roller 4Y provided to any one of the process units 1Y, 101, and 103Y according to an exemplary embodiment of the present invention are described.

FIG. 6 shows a schematic structure of the charging brush roller 4Y for a black image.

The charging brush roller 4Y of FIG. 6 includes the multiple fibrous members 6Y mounted on the rotary shaft member 5Y straightly perpendicular to the surface of the rotary shaft member 5Y.

In the structure of the charging brush roller 4Y of FIG. 6, the multiple fibrous members 6Y extend in a normal line direction with respect to the rotary shaft member 5Y.

FIG. 7 shows a schematic structure of a charging brush roller 4Y′ for a black image.

The charging brush roller 4Y′ of FIG. 7 includes multiple fibrous members 6Y′ mounted obliquely or slanted to a surface of a rotary shaft member 5Y′.

In the structure of the charging brush roller 4Y′ of FIG. 7, the multiple fibrous members 6Y′ do not extend in a normal line direction with respect to the rotary shaft member 5Y′. That is, the multiple fibrous members 6Y′ obliquely extend with respect to the rotary shaft member 5Y′.

The process unit 1Y used in Test 1 employed the charging brush roller 4Y including the multiple fibrous members 6Y mounted on the rotary shaft member 5Y straightly perpendicular to the surface of the rotary shaft member 5Y. The inventors of the present invention replaced the charging brush roller 4Y with the multiple fibrous members 6Y mounted on the rotary shaft member 5Y straightly perpendicular to the surface of the rotary shaft member 5Y to the charging brush roller 4Y′ with the multiple fibrous members 6Y′ mounted obliquely to a surface of the rotary shaft member 5Y′ to attach to the above-described test machine.

The inventors then evaluated the occurrence of filming by reproducing and outputting copies of a halftone chart as the inventors did in Test 1. As a result, the inventors found that, compared with the charging brush roller 4Y with the multiple fibrous members 6Y mounted on the rotary shaft member 5Y straightly perpendicular to the surface of the rotary shaft member 5Y, the charging brush roller 4Y′ with the multiple fibrous members 6Y′ mounted obliquely to the surface of the rotary shaft member 5Y′ can reduce the occurrence frequency of filming.

Accordingly, the printer 100 according to this exemplary embodiment of the present invention employs the charging brush roller 4Y′ with the multiple fibrous members 6Y′ mounted obliquely to the surface of the rotary shaft member 5Y′ to be provided to each of the process units 1Y, 101, and 103Y.

It is noted that the charging brush roller 4Y′, the rotary shaft member 5Y′, and the multiple fibrous members 6Y′ can be replaced to the charging brush roller 4Y, the rotary shaft member 5Y, and the multiple fibrous members 6Y in the descriptions and drawings of the present invention. That is, even when the charging brush roller 4Y only is shown in the drawings, the charging brush roller 4Y′ can be replaced to the charging brush roller 4Y if necessary.

Referring to FIG. 8, a schematic configuration of a process unit 201Y provided to the printer 100 according to another exemplary embodiment of the present invention is described.

The process unit 201Y of the printer 100 according to this exemplary embodiment of the present invention employs a so-called “cleaner-less system.” The cleaner-less system can perform an image forming process without using a dedicated unit for collecting residual toner from the surface of a photoconductor, i.e., the photoconductor 3Y. In other words, the cleaner-less system does not require a toner collecting unit or a cleaning unit. Specifically, after removing residual toner from the surface of the photoconductor, the cleaner-less system conveys and collects the residual toner to a toner container or to a developing unit for reusing, without causing the residual toner to return to the image carrier. The dedicated unit for collecting residual toner includes a cleaning blade.

Details of such a cleaner less system are described below.

There are generally three types of cleaner-less systems, which are spread type, catch-and-release type, and combination type that uses both the spread type and catch-and-release type.

The spread type cleaner-less system uses a toner spreading member such as a brush for slidably contacting a photoconductor. With the spread type cleaner-less system, the toner spreading member may scrape and/or spread residual toner on the photoconductor to reduce adherence of the residual toner with respect to the photoconductor. The residual toner remaining on the surface of the photoconductor is then electrostatically attracted by a developing member, (for example, a development sleeve and a developing roller) at or before a development region in which the developing member and the photoconductor are disposed opposite to each other. By so doing, the residual toner can be collected by the developing unit.

Before being collected by the developing unit, the residual toner passes a position at which an electrostatic latent image is optically formed. When the residual toner on the photoconductor is a relatively small amount, an adverse affect may not be exerted for forming the electrostatic latent image. However, when the residual toner contains toner particles that are charged to a polarity opposite to the proper polarity of the toner, the developing member cannot attract such oppositely charged toner particles contained in the residual toner. This may cause a defected image with a background contamination, for example.

To reduce or eliminate the occurrence of background contamination caused by the above-described oppositely charged toner, it is preferable to arrange a toner charging unit for charging the residual toner remaining on the surface of the photoconductor to the proper polarity of the toner between a transfer position (e.g., primary transfer nip) and a toner spreading position at which the residual toner is spread by the toner spreading member or between the toner spreading position and a development position.

Possible toner spreading members are, for example, a fixed brush with multiple conductive fibrous members attached to a metal plate, a unit casing, etc., a brush roller with multiple fibrous members arranged perpendicular to a surface of a metallic rotary shaft, a roller including an electrically conductive sponge body, and so forth.

The fixed brush can be formed with a relatively small amount of fibrous members, which may be less expensive. However, when the fixed brush is also used as a charging member for uniformly charging the surface of the photoconductor, the fixed brush cannot provide a sufficient uniformity in charging. Compared with the fixed brush, the brush roller is more suitable for a sufficient uniformity in charging.

The catch-and-release type cleaner-less system can use a rotating brush that moves continuously while contacting the surface thereof with the photoconductor. In this case, the rotating brush serves as a catch-and-release member.

The rotating brush temporarily catches the residual toner from the surface of the photoconductor. At a given timing, e.g., at a timing after a print job or at a timing between sheet processing operations during the print job, the residual toner caught on the rotating brush is released and transferred onto the surface of the photoconductor again. Then, the developing member electrostatically attracts the residual toner to collect into the developing unit.

A relatively large amount of residual toner remains on the photoconductor after a solid image has been formed or a jam has occurred. In such case, the spread type cleaner-less system may cause image deterioration due to the overload to the developing member. On the contrary, the catch-and-release type cleaner-less system can avoid the occurrence of such image deterioration by collecting the residual toner from the rotating brush to the developing member little by little.

The combination type cleaner-less system can use both functions of the spread type system and the catch-and-release type system.

Specifically, a rotary brush member which contacts the photoconductor or other similar latent image carrying member is used to perform as a toner spreading member as well as a catch-and-release member. While serving as a toner spreading member when only a DC voltage is applied, the rotary brush member may serve as a catch-and-release member, when necessary, by switching the bias from a DC bias voltage to an AC bias voltage superimposed on a DC bias voltage.

In FIG. 8, the process unit 201Y employs the catch-and-release type cleaner-less system. Specifically, while rotating at a given linear velocity in a clockwise direction in FIG. 8, the photoconductor 3Y contacts an outer surface of the intermediate transfer belt 61 to form a primary nip for yellow toner images. The fibrous members 6Y or 6Y′ of the charging brush roller 4Y or 4Y′ applies a charge bias to the photoconductor 3Y to uniformly charge the surface of the photoconductor 3Y to a minus polarity. At the same time, by the previously described action of the charge bias, residual toner remaining on the surface of the photoconductor 3Y is caught by the multiple fibrous members 6Y or 6Y′ of the charging brush roller 4Y or 4Y′. Then, at a given timing, e.g., at a timing after a print job or at a timing between sheet processing operations during the print job, the residual toner caught on the multiple fibrous members 6Y or 6Y′ while rotating is released and transferred onto the surface of the photoconductor 3Y again. Then, the developing roller 42Y electrostatically attracts the residual toner to collect into the developing unit 40Y.

After passing the primary nip for yellow toner images, the surface of the photoconductor 3Y then contacts the auxiliary charge roller 8Y before proceeding to the contact position with the charging brush roller 4Y or 4Y′. The auxiliary charge roller 8Y that applies a DC voltage of the minus polarity, which is same as the polarity of yellow toner, applies an auxiliary charge bias to the photoconductor 3Y before proceeding to the contact position of the charging brush roller 4Y. At the same time, the auxiliary charge roller 8Y performs charge injection to the reversely charged toner so that the reversely charged toner can be charged to the plus or regular polarity. Specifically, the residual toner adhering to the surface of the photoconductor 3Y after passing the primary nip for yellow toner image contacts the auxiliary charge roller 8Y before being temporarily caught by the charging brush roller 4Y. When contacting the auxiliary charge roller 8Y, a small amount of reversely charged toner particles contained in the residual toner may be charged to the regular polarity due to discharge or charge injection by the auxiliary charge roller 8Y.

The inventors have run the printer 100 with the above-described structures under the following conditions, and found the preferable conditions described below, which can reduce or prevent, where possible, defects such as charging non-uniformity and/or filming on the photoconductor of the printer 100.

(1) Conditions of the charging brush roller:

Material of fibrous member: NYLON6 (registered trademark) that includes carbon uniformly dispersed,

Thickness of fibrous member: 2 [denier] (Acceptable range: 3 deniers or smaller),

Density of fibrous members of a rotary shaft member: 260,000 [per inch²] (Acceptable range: 200,000 [per inch²] or greater),

Brush resistance: 10⁶Ω (Acceptable range: 10³Ω to 10⁸Ω),

Fiber resistance: 10⁸Ω (Acceptable range: 10⁵Ω to 10¹⁰Ω)

Moving direction of brush surface: Direction same as the moving direction of the surface of the photoconductor at the nip portion,

Amount of inroads of fibrous member with respect to photoconductor: 0.8 [mm] (Acceptable range: 0.1 to 1.4),

Ratio of linear velocities “V2/V1” : 2:1 (Acceptable range: 2:1 to 4:1),

Peak-to-peak voltage “Vpp” : 1.0 kV (Acceptable range: 0.5 to 1.3),

Frequency “f” : 500 Hz (Acceptable range: 100 to 1000),

Duty of alternating voltage: 45%,

DC component of charge bias: −500V,

Diameter of shearing: 13 mm,

Diameter of shaft: 5 mm,

Outer diameter of brush: 11 mm, and

Status of fibrous member: obliquely mounted to a surface of a rotary shaft member.

(2) Conditions of toner discharge from a charging brush roller:

Toner is discharged at a timing at least one of a timing between one sheet and the following sheet, a timing of starting a print job, and a timing of ending a print job; and

A discharge bias different from a charge bias is applied to the charging brush roller. For example, a bias voltage is not applied to an auxiliary charge roller while a direct voltage of −1000V is applied to a charging brush roller.

(3) Conditions of auxiliary charge roller

Roller part: hydrin rubber layer and surface protection layer,

Resistance: 1×10⁵Ω (Acceptable range: 10³ to 10⁸),

Outer diameter of roller part: 9 mm,

Outer diameter of cored bar under the rubber layer 6 mm,

Contact pressure: 1.5 N,

Rotation method: Rotated by rotations of a photoconductor held in contact with the auxiliary charge roller, and

Auxiliary charge bias: Direct current −1100V.

As described above, in the printer 100 according to an exemplary embodiment of the present invention, the linear velocity ratio, which is a ratio of the linear velocity “V2” of the charging brush roller 4Y to the linear velocity “V1” of the photoconductor 3Y, is set to equal to or smaller than 5:1. Therefore, according to the above-described reasons, abrasion of the photoconductor 3Y caused by the contact with the charging brush roller 4Y can be reduced.

Further, the printer 100 according to an exemplary embodiment of the present invention includes the charging brush roller 4Y, which includes multiple conductive fibrous members 6Y mounted on the rotary shaft member 5Y perpendicular to the surface of the rotary shaft member 5Y. The leading edge of the multiple fibrous members 6Y contacts the photoconductor 3Y serving as an electrostatic image carrier. Therefore, residual toner remaining on the surface of the photoconductor 3Y can be caught on the multiple fibrous members 6Y of the charging brush roller 4Y.

Further, the printer 100 according to an exemplary embodiment of the present invention includes the charging brush roller 4Y′ with the multiple fibrous members 6Y′ mounted obliquely to the surface of the rotary shaft member 5Y′. Therefore, according to the above-described reasons, the charging brush roller 4Y′ can reduce the occurrence frequency of filming compared to the charging brush roller 4Y having the multiple fibrous members 6Y mounted on the rotary shaft member 5Y straightly perpendicular to the surface of the rotary shaft member 5Y.

Further, the printer 100 according to an exemplary embodiment of the present invention includes the charge bias applying unit 10Y that applies a charge bias including an AC voltage with the peak-to-peak voltage Vpp within a range of from approximately 500V to approximately 1300V, to the charging brush roller 4Y. Therefore, according to the above-described reasons, the occurrence frequency of local charging non-uniformity on the photoconductor 3Y can remain within an allowable range.

Further, in the printer 100 according to an exemplary embodiment of the present invention, the charge nip is formed at a contact portion between the photoconductor 3Y and the charging brush roller 4Y, and the length of the charge nip in the brush surface moving direction is controlled to set to 0.5 mm or greater. Therefore, the occurrence of filming caused by the too small charge nip width beyond an allowable range can be avoided.

Further, in the printer 100 according to an exemplary embodiment of the present invention, it is controlled that the photoconductor 3Y is an image carrier that includes a cylinder-shaped drum with a diameter of 20 mm or greater, and a surface thereof continuously rotates with the rotations of a shaft part thereof and carries an electrostatic latent image thereon. Therefore, the occurrence of filming when the diameter of the photoconductor 3Y is too small can be avoided.

Further, the printer 100 according to an exemplary embodiment of the present invention includes the auxiliary charge roller 8Y serving as a second charging member. As described above, the auxiliary charge roller 8Y contacts the surface thereof with the surface of the photoconductor 3Y so that the auxiliary charge roller 8Y can charge the surface of the photoconductor 3Y before the surface of the photoconductor 3Y is uniformly charged by the charging brush roller 4Y. In addition, the printer 100 according to an exemplary embodiment of the present invention includes the charge bias applying unit 10Y to charge a charge bias including at least a DC voltage to the auxiliary charge roller 8Y. With such configuration, according to the above-described reasons, abrasion of the charging brush roller 4Y can be reduced.

Further, the printer 100 according to an exemplary embodiment of the present invention includes the developing unit 40Y in which the developing sleeve serving as a developer carrier carries toner on the surface thereof to develop an electrostatic latent image into a visible toner image. The printer 100 according to an exemplary embodiment of the present invention further includes the transfer unit 60 serving as a transfer unit including the intermediate transfer belt 61 serving as a transfer member so that the intermediate transfer belt 61 can transfer the toner image formed on the surface of the photoconductor 3Y onto a recording paper P. Further, the printer 100 according to an exemplary embodiment of the present invention is controlled to move residual toner adhering to the surface of the photoconductor 3Y from the photoconductor 3Y to the surface of the developing sleeve of the developing unit 40Y after the transfer process of the toner image formed on the photoconductor 3Y to a recording paper P at the primary nip by the transfer unit 60. With the above-described structure, the printer 100 according to an exemplary embodiment of the present invention achieves the above-described cleaner-less system. Accordingly, the printer 100 can avoid additional implementation of units, i.e., drum cleaning unit and provide cost reduction and downsizing of the apparatus.

Further, the above-described image forming methods can be performed by or with the above-described configurations of the printer 100 according to an exemplary embodiment of the present invention.

The above-described example embodiments are illustrative, and numerous additional modifications and variations are possible in light of the above teachings. For example, elements and/or features of different illustrative and exemplary embodiments herein may be combined with each other and/or substituted for each other within the scope of this disclosure. It is therefore to be understood that, the disclosure of this patent specification may be practiced otherwise than as specifically described herein.

Obviously, numerous modifications and variations of the present invention are possible in light of the above teachings. It is therefore to be understood that, the invention may be practiced otherwise than as specifically described herein.

What is claimed is:

1. An image forming apparatus, comprising:
an image carrier configured to carry an image on a surface thereof and rotate continuously;
a charging unit including a first charging member configured to rotate with the image carrier at a portion contacting the image carrier and discharge a given amount of bias to the portion and uniformly charge the surface of the image carrier while contacting the surface of the image carrier;
a charge bias applying unit configured to apply a charge bias including at least an alternating current voltage to the first charging member;
a writing unit configured to write a latent image on the charged surface of the image carrier; and
a developing unit configured to develop the latent image formed on the surface of the image carrier into a visible toner image,
wherein a ratio of a frequency of the alternating current voltage to a surface linear velocity of the image carrier is within a range of from approximately 1.5:1 to approximately 4:1 and a ratio of a surface linear velocity of the first charging member to the surface linear velocity of the image carrier is at least 2:1.

2. The image forming apparatus according to claim 1, wherein the ratio of the surface linear velocity of the first charging member to the surface linear velocity of the image carrier is equal to or smaller than 5:1.

3. The image forming apparatus according to claim 1, wherein the first charging member comprises a charging brush roller having multiple conductive fibrous members mounted on a rotary shaft member perpendicular to a surface of the rotary shaft member,
a leading edge of each of the multiple fibrous members of the charging brush roller contacting the image carrier.

4. The image forming apparatus according to claim 3, wherein the multiple fibrous members of the charging brush roller are mounted obliquely to the surface of the rotary shaft member.

5. The image forming apparatus according to claim 1, wherein the charge bias applying unit applies, to the first charging member, a charge bias including the alternating current voltage with a peak-to-peak voltage with within a range of from approximately 500V to approximately 1300V.

6. The image forming apparatus according to claim 1, wherein a charge nip is formed at a contact portion between the image carrier and the first charging member and a length of the charge nip in a surface moving direction of the first charging member is 0.5 mm or greater.

7. The image forming apparatus according to claim 1, wherein the image carrier comprises a cylinder-shaped member with a diameter of 20 mm or greater and carries a latent image on the surface thereof rotating continuously.

8. The image forming apparatus according to claim 1, further comprising a second charging member configured to contact a surface thereof with the surface of the image carrier and charge the surface of the image carrier before the surface of the image carrier is uniformly charged by the first charging member,
wherein the charge bias applying unit applies a charge bias including at least a direct current voltage to the second charging member.

9. The image forming apparatus according to claim 1, further comprising a transfer unit including a transfer member and configured to transfer the image formed on the image carrier onto a recording medium,
wherein the developing unit comprises a developer carrier and develops the latent image into the toner image with toner carried on a surface of the developer carrier and moves residual toner adhering to the surface of the image carrier from the image carrier to the surface of the developer carrier after the transfer of the image formed on the image carrier to the recording medium by the transfer unit.

10. A method of image forming, comprising:
rotating an image carrier to move a surface thereof continuously;
rotating a first charging member to move a surface thereof with the image carrier at a portion contacting the first charging member with the image carrier;
applying a first charge bias including at least an alternating current voltage, to the first charging member;
applying a second charge bias between the first charging member and the image carrier while rotating and contacting the first charging member with the image carrier and uniformly charging the surface of the image carrier;
writing a latent image on the charged surface of the image carrier;
developing the latent image formed on the surface of the image carrier into a visible toner image; and
maintaining a ratio of a frequency of the alternating current voltage to a surface linear velocity of the image carrier within a range of from approximately 1.5:1 to approximately 4:1 and a ratio of a surface linear velocity of the first charging member to the surface linear velocity of the image carrier at least 2:1.

11. The method according to claim 10, further comprising maintainging the ratio of the surface linear velocity of the first charging member to the surface linear velocity of the image carrier at no more than 5:1.

12. The method according to claim 10, wherein the first charging member includes a charging brush roller and the applying the second charge bias includes contacting leading edges of multiple fibrous members of the charging brush roller with the image carrier.

13. The method according to claim 12, wherein the multiple fibrous members are mounted obliquely on a rotary shaft member of the charging brush roller.

14. The method according to claim 10, further comprising maintaining controlling the alternating current voltage with a peak-to-peak voltage within a range of from approximately 500V to approximately 1300V.

15. The method according to claim 10, further comprising controlling a charge nip to have a length of 0.5 mm or greater in a surface moving direction of the first charging member.

16. The method according to claim 10, further comprising continuously rotating the image carrier including a cylinder-shaped member with a diameter of 20 mm or greater.

17. The method according to claim 10, further comprising:
charging the image carrier before the applying the second charge bias to uniformly charge the surface of the image carrier; and
applying a charge bias including at least a direct current voltage for the charging.

18. The method according to claim 10, further comprising:
transferring the image formed on the image carrier onto a recording medium; and
moving residual toner remaining on the image carrier from the image carrier to a developer carrier.
